(19) United States
(12) Patent Application Publication
(10) Pub. No.: US 2004/0164131 A1
(43) Pub. Date: Aug. 26, 2004

(54) Solder applying method and solder applying apparatus

(75) Inventor: Haruo Watanabe, Sakata-shi (JP)

Correspondence Address: WILLIAM COLLARD, COLLARD & ROE, P.C., 1077 NORTHERN BOULEVARD, ROSLYN, NY, 11576, US

(73) Assignee: TECT Corporation

(21) Appl. No.: 10/788,019

(22) Filed: Feb. 26, 2004

Related U.S. Application Data
(63) Continuation of application No. 10/382,432, filed on Mar. 6, 2003, now abandoned.

(30) Foreign Application Priority Data
Mar. 8, 2002 (JP) 64358/2002
Mar. 5, 2003 (JP) 58764/2003

(51) Int. Cl. B23K 31/02

(52) U.S. Cl. 228/261; 228/33; 228/43; 228/207; 228/223

(57) ABSTRACT

An electronic component 10 is moved along a predetermined path in a first direction D1 by a work conveying unit 16. From a second direction substantially orthogonal to the first direction, a solder material is applied, by injection, to lead terminals 11 of the electronic component by a solder supply unit 14. While the applied solder material is in a molten state, a high-temperature fluid is sprayed to the lead terminals by a fluid spray unit 15. It is desirable that the direction of spraying of the high-temperature fluid is adjustable.

This application is a continuation of application Ser. No. 10/382,432 filed Mar. 6, 2003, now abandoned, and claims priority to prior Japanese applications JP 2002-64358 and 2003-58764, the disclosures of which are incorporated herein by reference.

### BACKGROUND OF THE INVENTION

The present invention relates to a method and apparatus (herein referred to as “solder applying method and solder applying apparatus”) for carrying out soldering or applying solder coating to lead terminals or the like of an electronic component.

Among electronic components having IC chips etc., there are ones that are provided with lead terminals. When mounting such electronic components onto various electronic equipments or devices, soldering may be applied to lead terminals. Further, prior to the soldering, solder coating may also be applied to the lead terminals in advance.

Conventionally, the soldering or solder coating of this type is, in general, implemented by immersing, for a fixed time, lead terminals of an electronic component in a solder bath where the solder material overflows and circulates. Immersion of lead terminals into the solder bath may also be carried out continuously. For overflowing the solder material from the solder bath, a pump is used.

On the other hand, upon soldering, a solder projection of strange appearance called a horn, a bridge short-circuiting lead terminals, or the like may be formed at a soldering portion. It is possible to prevent the formation of such solder adhesion failure like the solder projection, the bridge or the like by applying flux to the lead terminals to lower the surface tension of solder in advance, then performing connection by soldering. However, taking into consideration materials of which use is restricted by the fluorine regulation, fluxes with small content of components for lowering the surface tension have been recently used in general. Therefore, only by applying the flux to a soldering portion before soldering, the surface tension becomes large due to oxygen in the air when solder at the soldering portion is separated from molten solder, so that the solder adhesion failure can not be fully prevented.

Therefore, it has been proposed to use nitrogen gas as means for lowering the surface tension of solder, along with the application of flux. In that case, prevention of the solder bridge or horn is sought by disposing in an airtight space the whole soldering apparatus or a unit (molten solder bath) for performing soldering, or giving it a sealed structure, and constantly introducing nitrogen gas to provide an atmosphere where oxygen is excluded.

However, upon overflowing the solder material from the solder bath, pulsating flow or vortex caused by an operation of a pump may be generated in the solder material when the solder material flows out, or the outflow shape of the solder material may be disturbed due to the shape of flexible tape used in this apparatus, or the like. In those cases, there is a possibility that the amount of the solder material contacting lead terminals of an electronic component becomes unstable, the solder adheres to unnecessary portions, the position or thickness of solder coating becomes non-uniform, or the so-called bridge that short-circuits adjacent lead terminals is generated in products.

Further, when nitrogen gas is used, since nitrogen gas is constantly sent even to unnecessary portions other than the soldering portion, the running cost of nitrogen gas increases. Further, since it is disposed in the space sealed to a certain degree, the concentration of nitrogen gas at the soldering portion is reduced due to flux gas generated from the flux upon soldering, so that the solder adhesion failure may be generated after all.

### SUMMARY OF THE INVENTION

It is therefore an object of the present invention to provide a solder applying method that can reduce solder adhesion failure such as a solder projection or bridge.

It is another object of the present invention to provide a solder applying apparatus that can reduce solder adhesion failure such as a solder projection or bridge.

According to one aspect of the present invention, there is obtained a solder applying method comprising a first step of moving a work along a predetermined path in a first direction, a second step of applying, by injection, a solder material to a predetermined area of said work from a second direction substantially orthogonal to said first direction, and a third step of spraying a high-temperature fluid to said predetermined area after said second step.

According to another aspect of the present invention, there is obtained a solder applying apparatus comprising a work conveying unit for moving a work along a predetermined path in a first direction, a solder injection unit for injecting a solder material to a predetermined area of said work from a second direction substantially orthogonal to said first direction, and a fluid spray unit for spraying a high-temperature fluid to said predetermined area in a position downstream of said solder injection unit in said first direction.

### BRIEF DESCRIPTION OF THE DRAWINGS

FIG. 1 is a front schematic view of a solder applying apparatus according to an embodiment of the present invention;

FIG. 2 is an explanatory sectional view at a portion of a solder supply unit of the solder applying apparatus of FIG. 1;

FIG. 3 is a front view of an electronic component having lead terminals applied with a solder material by the solder supply unit of FIG. 2;

FIG. 4 is an explanatory sectional view at a portion of a hot air supply unit of the solder applying apparatus of FIG. 1; and

FIG. 5 is a front view of an electronic component having lead terminals of which applied solder has been processed by the hot air supply unit of FIG. 1.

### DESCRIPTION OF THE PREFERRED EMBODIMENTS

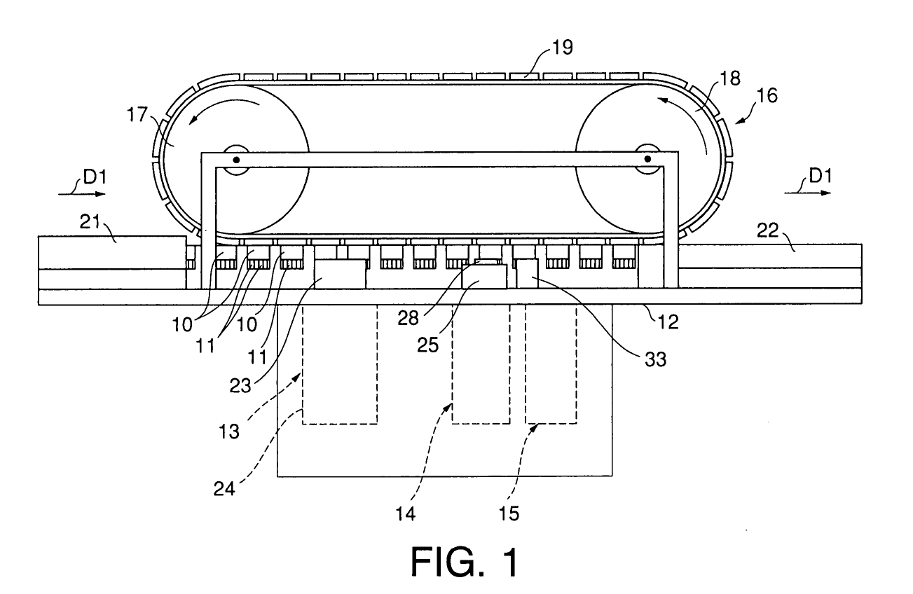

Referring to FIG. 1, a solder applying apparatus according to an embodiment of the present invention will be described.

The shown solder applying apparatus is an apparatus for executing a solder applying operation that applies solder coating to metal lead terminals 11 of electronic components 10 as works, and includes an apparatus frame 12. In the apparatus frame 12, a flux supply unit 13, a solder supply unit 14, and a hot air supply unit (air knife) 15 as a fluid spray unit are juxtaposed in a horizontal first direction D1 in the order named. Further, a work conveying unit 16 extends in the first direction D1 so as to cross these units 13, 14, 15. The work conveying unit 16 has a pair of pulleys or sprockets 17, 18 spaced apart in the first direction D1, and an endless belt or endless chain 19 traversing therebetween. Either one of the sprockets 17, 18 is driven by a non-shown motor to rotate, so that the endless chain 19 is conveyed.

Each electronic component 10 is supplied to the work conveying unit 16 from a work supply portion 21, engages with the endless chain 19, and conveyed in the first direction D1 along a predetermined path. During conveyance, the electronic component 10 passes through the flux supply unit 13, the solder supply unit 14 and the hot air supply unit 15 in order and, while doing so, a solder applying operation for the lead terminals 11 is carried out as described later. Thereafter, the electronic component 10 is handed over to a work discharge portion 22 from the endless chain 19.

The flux supply unit 13 includes a flux applying mechanism 23 that applies flux to the whole area of the electronic component 10 transferred by the work conveying unit 16, preferably, only to the lead terminals 11, and a flux bath 24 storing the flux. The flux applying mechanism 23 and the flux bath 24 are connected to each other by a forward-path conduit and a return-path conduit (either not shown). A pump (not shown) is connected to the forward-path conduit. This pump is for supplying the flux in the flux bath 24 to the flux applying mechanism 23 through the forward-path conduit. A residual portion of the flux applied to the electronic component 10 is returned to the flux bath 24 through the return-path conduit. Having passed through the flux supply unit 13, the electronic component 10 is in the state where the flux is applied to a necessary portion. As the flux, it is desirable to use one with small content of components for lowering the surface tension.

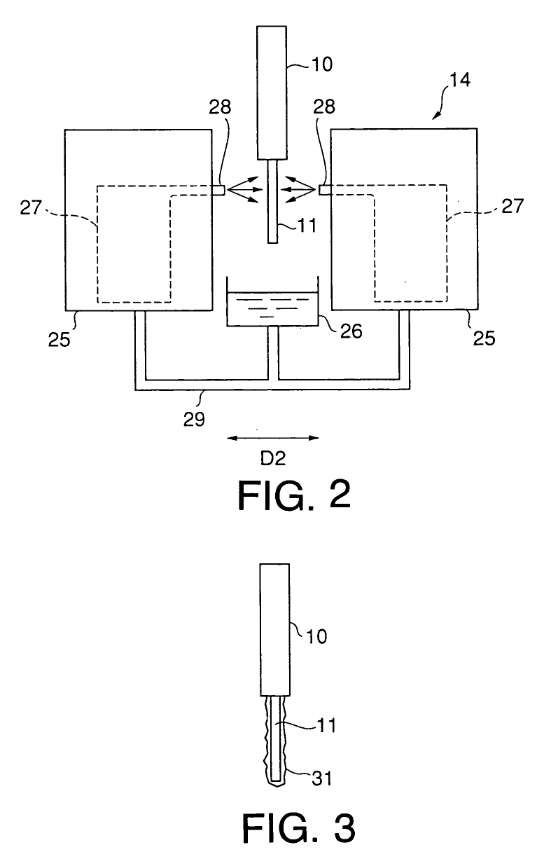

Referring also to FIG. 2 together with FIG. 1, the solder supply unit 14 will be described.

The solder supply unit 14 includes a pair of solder injection units 25 arranged on both sides of the foregoing predetermined path, and a solder recovery unit 26 arranged under the predetermined path. Each solder injection unit 25 has a solder bath 27 storing a solder material made into a molten state by heating (hereinafter may also be referred to as “solder solution”), and a solder injection nozzle 28 that injects the solder solution from a horizontal second direction D2 substantially orthogonal to the first direction D1. The solder injection nozzles 28 of the pair of solder injection units 25 confront each other in the second direction D2. The solder recovery unit 26 is connected to the solder baths 27 through a solder recovery conduit 29. As the solder material, it is desirable to use one made of a material selected from one kind or several kinds of Sn, Zn, P, Fe, Sb, Bi, etc., having a residual portion made of copper, and not containing either lead or a lead alloy. However, the solder material may contain al least one of the lead and the lead alloy.

Each solder injection unit 25 injects the solder material toward a predetermined area of the electronic component 10 transferred by the work conveying unit 16, i.e. the lead terminals 11. Specifically, it injects the solder solution in the solder bath 27 toward the lead terminals 11 from the solder injection nozzle 28 in the second direction D2. As a result, the solder material is applied to the lead terminals 11. The solder material that has dropped without adhering to the lead terminals 11 in this operation is recovered by the solder recovery unit 26 and returned to the solder baths 27 through the solder recovery conduit 29. Thus, the solder material is held at substantially a constant temperature through circulation thereof.

Having passed through the solder supply unit 14, a solder material 31 adheres to the lead terminals 11 of the electronic component 10 as illustrated in FIG. 3. In this state, ruggedness tends to remain on the surface of the solder material 31 due to adhesion of the excessive solder material to the lead terminals 11. Since the solder material 31 is in a molten state immediately after the solder material has been adhered to the lead terminals 11, smoothing of the surface of the solder material 31 is attempted, utilizing this molten state, by the use of the hot air supply unit 15 which will be described hereinbelow.

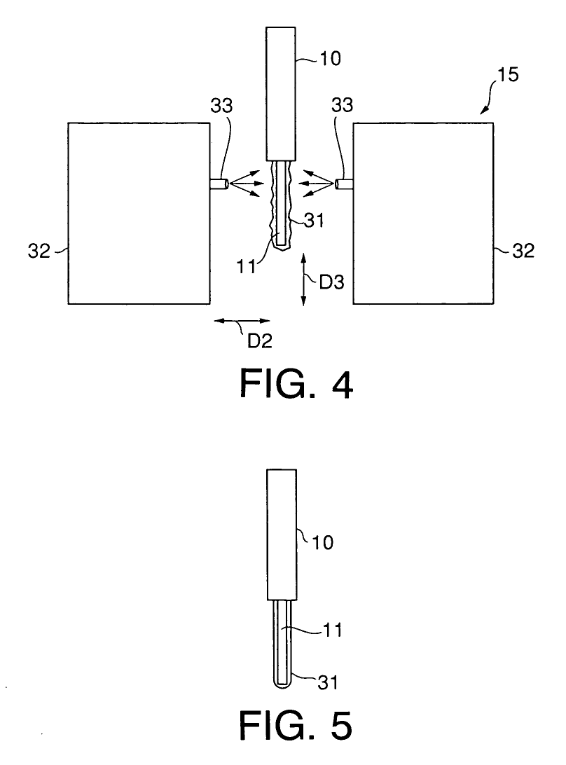

Referring also to FIG. 4 together with FIG. 2, the hot air supply unit 15 will be described.

The hot air supply unit 15 is adjacent to the solder supply unit 14 and includes a pair of blowers 32 arranged on both sides of the foregoing predetermined path. Each blower 32 produces a high-temperature fluid made of inert gas such as nitrogen at 150° C. to 350° C., and so on. The high-temperature fluid may have a temperature that is higher than 350° C. or lower than 150° C.

The high-temperature fluid is blown out as hot air from a hot air injection nozzle 33 provided in each blower 32. The high-temperature fluid may be supplied to the blowers 32 from non-shown gas supply means.

The hot air is sprayed from the hot air injection nozzle 33 of each blower 32 toward the lead terminals 11 of the electronic component 10 transferred by the work conveying unit 16. By means of spaying of the hot air, the excessive solder material is dropped from the solder material in the molten state adhering to the lead terminals 11, and recovered by the solder recovery unit 26. As a result, as shown in FIG. 5, the ruggedness on the surface of the solder material 31 of the lead terminals 11 is reduced so that solder coating with the smoothed surface is obtained. In addition, the hot air may serve to process the solder coating into an alloy that is made of each of the terminals 11 and the solder material adhered thereto. When such an alloy was made, reliability of the solder coating is increased.

The hot air injection nozzle 33 is generally directed in the second direction D2, but it is desirable to design it variable so as to enable adjustment of the direction of injection of the high-temperature fluid. Further, it is also desirable to change the direction of the hot air injection nozzle 33 continuously or intermittently upon spraying the high-temperature fluid. The change in direction of the hot air injection nozzle 33 may be in the plane spreading in the first and second directions D1, D2, or may be in the plane spreading in a third direction D3 orthogonal to the first and second directions D1, D2 and the second direction D2, or may, of course, be in combination of these changes.

Next, a method of continuously implementing solder adhesion to the lead terminals 11 of many electronic components 10 using the foregoing solder applying apparatus will be described. Here, it is assumed that distal end portions of the lead terminals 11 are joined together so that many electronic components 10 are arranged in a belt fashion.

The motor is started in the state where the electronic components 10 are supported by the endless chain 19. A rotational force of the motor is transmitted to the sprocket 17 or 18 via proper speed reduction means. As a result, the endless chain 19 is rotated counterclockwise in FIG. 1 to convey the electronic components 10. In this case, the rotational speed of the endless chain 19, i.e. the conveying speed of the electronic components 10, is non-stage variable.

The electronic component 10 is first positioned at the flux supply unit 13. Here, the pump in the flux applying mechanism 23 is operated to apply, by spraying, the flux to at least a predetermined area of the electronic component 10. It is not limited to the spraying. Application of the flux may also be performed by so-called immersion.

Further, the electronic component 10 applied with the flux is conveyed to a squeegee mechanism (not shown) where the flux applied more than necessity is removed.

Subsequently, the electronic component 10 is transferred to the solder supply unit 14. When the electronic component 10 arrives at the solder supply unit 14, each solder injection unit 25 injects the solder material toward the lead terminals 11 from the solder injection nozzle 28. Thus, the application of the solder material to the lead terminals 11 is carried out. Since the solder material is injected to a predetermined area, i.e. an application surface, of the lead terminals 11 from the same line in the horizontal direction, the applied position of the solder material is always correct, further, the application amount thereof is small, and the application time can also be largely reduced. Further, since the solder can be applied to the body of a lead frame member under a constant pressure, the solder material can be applied to the lead terminals 11 reliably and firmly.

Then, the electronic component 10 is transferred to the hot air supply unit 15. When the electronic component 10 arrives at the hot air supply unit 15, the blowers 32 inject inert gas as hot air from the hot air injection nozzles 33 without delay. The injection angle of each hot air injection nozzle 33 can be properly adjusted, and the gas after the injection is exhausted by exhausting means such as an exhaust fan. Alternatively, an active gas may be used as the hot air.

Thus, the ruggedness on the surface of the solder material applied to the lead terminals 11 is reduced so that the surface of the solder coating is smoothed. Therefore, in the solder coating of the lead terminals 11 of the electronic component 10, the generation of the solder adhesion failure such as the solder projection or bridge is reduced.

In the foregoing, the description has been made exclusively about the case where the solder coating is applied to the lead terminals 11 of the electronic component 10. However, it can be naturally used likewise for an operation of continuously performing a so-called soldering operation to a portion of the lead terminal 11. Further, it is applicable not only to the lead terminal of the electronic component, but also to a case of applying the solder material to various members or portions.

What is claimed is:

1. A solder applying method comprising a first step of moving a work along a predetermined path in a first direction, a second step of applying, by injection, a solder material to a predetermined area of said work from a second direction substantially orthogonal to said first direction, and a third step of spraying a high-temperature fluid to said predetermined area after said second step.

2. A solder applying method as claimed in claim 1, wherein a material not containing either lead or a lead alloy is used as said solder material in said second step.

3. A solder applying method as claimed in claim 1, wherein hot air at 150° C. to 350° C. is used as said high-temperature fluid in said third step.

4. A solder applying method as claimed in claim 1, wherein a direction of spraying of said high-temperature fluid is adjusted in said third step.

5. A solder applying method as claimed in claim 1, wherein said solder material is injected from both sides of said predetermined path in said second step.

6. A solder applying method as claimed in claim 1, wherein said high-temperature fluid is sprayed to said predetermined area from both sides of said predetermined path in said third step.

7. A solder applying method as claimed in claim 1, including a step of applying flux to said predetermined area prior to said second step.

8. A solder applying apparatus comprising a work conveying unit for moving a work along a predetermined path in a first direction, a solder injection unit for injecting a solder material to a predetermined area of said work from a second direction substantially orthogonal to said first direction, and a fluid spray unit for spraying a high-temperature fluid to said predetermined area in a position downstream of said solder injection unit in said first direction.

9. A solder applying apparatus as claimed in claim 8, wherein said solder injection unit uses a material not containing either lead or a lead alloy as said solder material.

10. A solder applying apparatus as claimed in claim 8, wherein said fluid spray unit uses hot air at 150° C. to 350° C. as said high-temperature fluid.

11. A solder applying apparatus as claimed in claim 8, wherein said fluid spray unit is provided with a nozzle that is variable in spraying direction of said high-temperature fluid.

12. A solder applying apparatus as claimed in claim 8, wherein said solder injection unit injects said solder material from both sides of said predetermined path.

13. A solder applying apparatus as claimed in claim 8, wherein said fluid spray unit sprays said high-temperature fluid to said predetermined area from both sides of said predetermined path.

14. A solder applying apparatus as claimed in claim 8, including a flux applying unit for applying flux to said predetermined area in a position upstream of said solder injection unit in said first direction.

15. A solder applying apparatus as claimed in claim 8, wherein said flux applying unit, said solder injection unit and said fluid spray unit are arranged in said first direction in the order named.

16. A solder applying apparatus as claimed in claim 15, wherein said solder injection unit and said fluid spray unit are arranged adjacent to each other.

17. A solder applying apparatus as claimed in claim 8, wherein said solder injection unit further includes a solder bath accommodating said solder material, and a solder injection nozzle that injects said solder material.

18. A solder applying apparatus as claimed in claim 8, wherein said fluid spray unit has a movable hot air injection nozzle with an outlet for said high-temperature fluid.

19. A solder applying apparatus as claimed in claim 18, wherein said hot air injection nozzle is movable in said first direction and a direction opposite thereto.

20. A solder applying apparatus as claimed in claim 18, wherein said hot air injection nozzle is movable in a third direction orthogonal to said first and second directions.
